(19) United States
(12) Patent Application Publication
(10) Pub. No.: US 2014/0119738 A1
(43) Pub. Date: May 1, 2014

(54) SINGLE-LAYER OPTICAL POINT-TO-POINT NETWORK

(71) Applicant: ORACLE INTERNATIONAL CORPORATION, Redwood City, CA (US)

(72) Inventors: Xuezhe Zheng, San Diego, CA (US); Pranay Koka, Austin, TX (US); Herbert D. Schwetman, JR., Austin, TX (US); Ronald Ho, Mountain View, CA (US); Ashok V. Krishnamoorthy, San Diego, CA (US)

(73) Assignee: ORACLE INTERNATIONAL CORPORATION, Redwood City, CA (US)

(21) Appl. No.: 13/666,548

(22) Filed: Nov. 1, 2012

(51) Int. Cl. H04B 10/02

(52) U.S. Cl. 398/139

(57) ABSTRACT

In a multi-chip module (MCM), first and second optical waveguides convey optical signals among integrated circuits. The first and second optical waveguides may be implemented in a first layer or plane on a substrate. Moreover, bridge chips in a second plane may be used to couple the optical signals between the first or second optical waveguides and the integrated circuits. By using a single layer for optical routing, the MCM may provide a point-to-point network among the integrated circuits without optical-waveguide crossing.

### CROSS-REFERENCE

This application is related to U.S. application Ser. No. 13/648,140, entitled “Opportunistic Bandwidth Stealing in Optical Networks,” by Arslan Zulfiqar, Pranay Koka and Herbert D. Schwetman, Attorney Docket Number ORA13-0240, filed on Oct. 9, 2012, the contents of which are herein incorporated by reference.

### GOVERNMENT LICENSE RIGHTS

This invention was made with Government support under Agreement No. HR0011-08-9-0001 awarded by DARPA. The Government has certain rights in the invention.

### BACKGROUND

1. Field

The present disclosure generally relates to optical networks. More specifically, the present disclosure relates to a multi-chip module (MCM) that includes integrated circuits that communicate via an optical network.

2. Related Art

Wavelength division multiplexing (WDM), which allows a single optical connection to carry multiple optical links or channels, and can be used to provide: very high bit rates, very high bandwidth densities and very low power consumption. As a consequence, researchers are investigating the use of WDM to facilitate inter-chip communication. For example, in one proposed architecture chips in an array (which is sometimes referred to as a multi-chip module or MCM, or a ‘macrochip’, and the chips are sometimes referred to based on the locations or ‘sites’ where they are placed in the array) are coupled together by an optical network that includes optical interconnects (such as silicon optical waveguides).

In order to use photonic technology in interconnect applications, an efficient design is desired for the optical network. In particular, the optical network ideally provides: a high total peak bandwidth; a high bandwidth for each logical connection between any two sites in the array; low arbitration and connection setup overheads; low power consumption; and bandwidth reconfigurability.

A variety of optical network topologies having different characteristics and contention scenarios have been proposed to address these challenges in interconnect applications. In one existing optical network topology, the optical waveguides that interconnect the sites in the MCM are implemented in two layers on a substrate in order to eliminate optical-waveguide crossings in a fully connected optical network. In particular, as shown in FIG. 1, which presents a block diagram illustrating an existing two-layer optical link, an optical signal may be transitioned from one layer to another at locations other than where optical waveguides in a two-dimensional array would otherwise cross. While this approach can reduce cross-talk in the MCM, in this design there are four inter-layer optical couplings in each WDM optical link. Using existing inter-layer optical couplers, the four inter-layer optical couplers shown in FIG. 1 will result in an optical loss of 12 dB. This may limit the energy efficiency of the WDM optical links and the optical network, which can increase the power consumption of the MCM.

Hence, what is needed is an MCM with an optical network that does not suffer from the above-described problems.

### SUMMARY

One embodiment of the present disclosure provides a multi-chip module (MCM). This MCM includes: first optical waveguides, in a first plane, which convey optical signals from a set of light sources that are external to the MCM; integrated circuits that receive the optical signals, and transmit and receive modulated optical signals when communicating information among the integrated circuits; second optical waveguides, in the first plane, that convey the modulated optical signals among the integrated circuits; and bridge chips, in a second plane, optically coupled to the first optical waveguides, the second optical waveguides and the integrated circuits. These bridge chips convey the optical signals from the first optical waveguides to the integrated circuits, and convey the modulated optical signals to and from the second optical waveguides and the integrated circuits. Moreover, the MCM provides a point-to-point network among the integrated circuits without optical-waveguide crossing.

Note that the first optical waveguides and the second optical waveguides may be implemented in the same layer on a substrate. For example, the first optical waveguides and the second optical waveguides may be implemented on the substrate using silicon-on-insulator technology.

Furthermore, the first optical waveguides may provide minimum distance optical-waveguide routing between the set of light sources and the integrated circuits and/or the second optical waveguides may provide minimum distance optical-waveguide routing among the integrated circuits.

In some embodiments, the second optical waveguides include multiple overlapping segments between sources and destinations in the integrated circuits.

Additionally, the point-to-point network may provide dedicated optical paths among the integrated circuits.

In some embodiments, the MCM facilitates simultaneous communication among the integrated circuits.

Note that the point-to-point network may exclude shared resources in optical paths among the integrated circuits.

Moreover, a given optical path between a given pair of integrated circuits in the point-to-point network may include two optical couplers to convey the given modulated optical signal between the first plane and the second plane in the given optical path.

Furthermore, the MCM may include third optical waveguides, optically coupled to the bridge chips, which convey the modulated optical signals to locations external to the MCM.

Another embodiment provides a system that includes: the set of light sources that the output optical signals having carrier wavelengths; and the MCM.

Another embodiment provides a method for communicating information in the MCM. During the method, the optical signals are received from the set of light sources, which are external to the MCM, at the integrated circuits in the MCM using the first optical waveguides, where the first optical waveguides are in the first plane. Then, the modulated optical signals are transmitted and received when communicating information among the integrated circuits. Next, the modulated optical signals are conveyed among the integrated circuits using the second optical waveguides in the first plane and the bridge chips in the second plane, where the bridge chips optically couple the integrated circuits and the first optical waveguides and optically couple the integrated circuits and the second optical waveguides. Moreover, the modulated optical signals are conveyed among the integrated circuits using the point-to-point network without optical-waveguide crossing.

### BRIEF DESCRIPTION OF THE FIGURES

FIG. 1 is a block diagram illustrating an existing two-layer optical link.

FIG. 2 is a block diagram illustrating a multi-chip module (MCM) in accordance with an embodiment of the present disclosure.

FIG. 3 is a block diagram illustrating a single-layer optical link in the MCM of FIG. 2 in accordance with an embodiment of the present disclosure.

FIG. 4 is a block diagram illustrating an MCM in accordance with an embodiment of the present disclosure.

FIG. 5 is a block diagram illustrating optical routing in MCM 400 in accordance with an embodiment of the present disclosure.

FIG. 6 is a block diagram illustrating an MCM in accordance with an embodiment of the present disclosure.

FIG. 7 is a block diagram illustrating a system that includes an MCM in accordance with an embodiment of the present disclosure.

FIG. 8 is a flow chart illustrating a method for communicating information in an MCM in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a multi-chip module (MCM), a system that includes the MCM, and a method for communicating information in the MCM are described. In this MCM, first and second optical waveguides convey optical signals among integrated circuits (which are sometimes referred to as ‘chips’). The first and second optical waveguides may be implemented in a first layer or plane on a substrate. Moreover, bridge chips in a second plane may be used to couple the optical signals between the first or second optical waveguides and the integrated circuits. By using a single layer for optical routing, the MCM may provide a point-to-point network among the integrated circuits without optical-waveguide crossing.

Using this communication technique, optical links among the integrated circuits in the MCM may use fewer inter-layer optical couplers, thereby reducing optical losses. For example, an optical link between a given pair of integrated circuits may include two inter-layer optical couplers. In this way, the optical network in the MCM may provide a suitable balance of high bandwidth, low latency and low power consumption for use in interconnect applications.

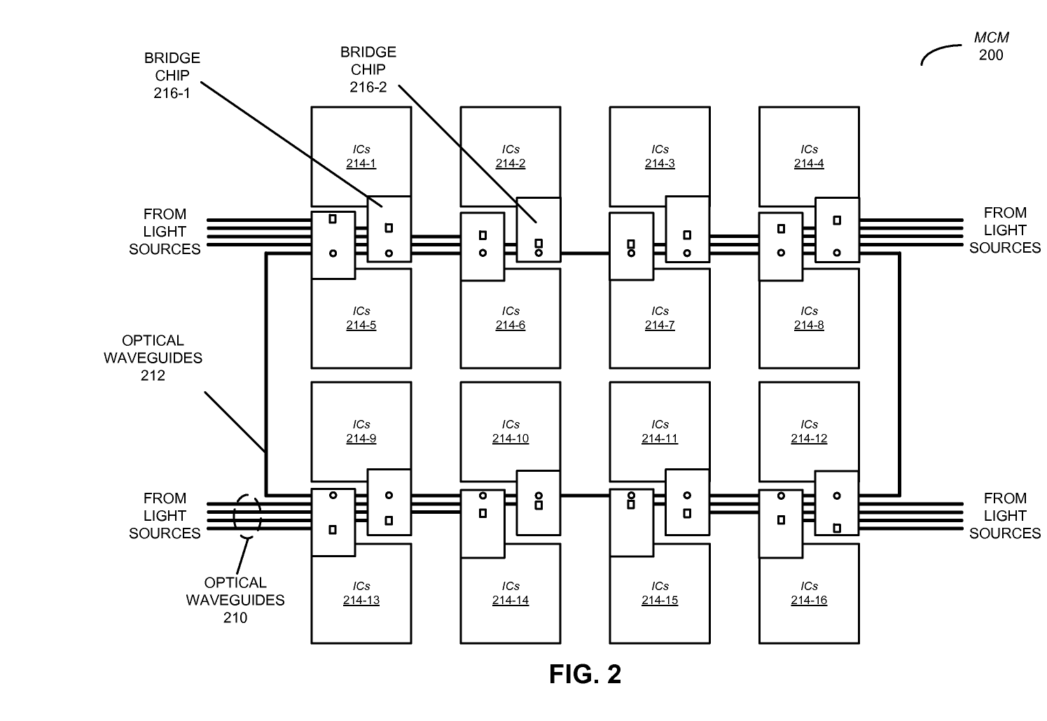

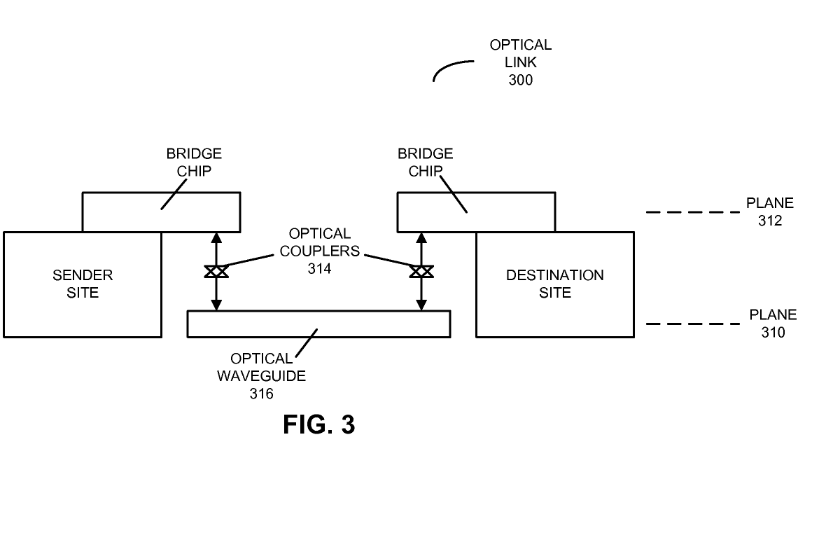

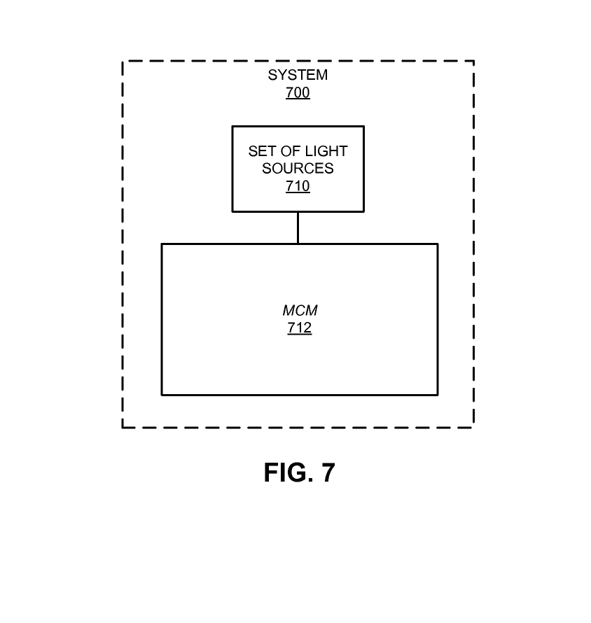

We now describe embodiments of the MCM. FIG. 2 presents a block diagram illustrating an MCM 200, which is sometimes referred to as a ‘macrochip.’ In this MCM, integrated circuits (ICs) 214 (such as processors and/or memory chips) may be arranged in an array. Optical waveguides 210, which may be in a plane 310 (FIG. 3), may be optically coupled to rows in the array (or, more generally, a first direction in the array). These optical waveguides may convey optical signals from a set of light sources 710 (FIG. 7) that are external to MCM 200 to integrated circuits 214. Moreover, integrated circuits 214 may receive the optical signals, and may transmit and receive modulated optical signals when communicating information among integrated circuits 214. For example, a transmitter in a given integrated circuit may modulate a carrier wavelength in the optical signals using a ring-resonator modulator, an electro-optical modulator or a Mach-Zehnder interferometer optical modulator, and a wavelength-selective drop filter in a receiver in the given integrated circuit may receive a modulated optical signal from another integrated circuit.

Furthermore, optical waveguides 212, which may be in plane 310 (FIG. 3), may also be optically coupled to rows in the array (or, more generally, the first direction or a second direction in the array). These optical waveguides may convey the modulated optical signals among integrated circuits 214. While optical waveguides 212 appear to be a ‘closed ring’ in FIG. 2, optical waveguides 212 may be implemented as multiple optical-waveguide segments among source and destination sites, so the ‘closed ring’ may actually include overlapping optical-waveguide segments.

Additionally, bridge chips 216, which may be in a plane 312 (FIG. 3), may be optically coupled to optical waveguides 210, optical waveguides 212 and integrated circuits 214. These bridge chips may convey the optical signals from optical waveguides 210 to integrated circuits 214, and may convey the modulated optical signals to and from optical waveguides 212 and integrated circuits 214. For example, as described below in FIG. 3, bridge chips 216 may traverse all of optical waveguides 210 and 212 in plane 312 (FIG. 3). By using a single layer for optical routing (i.e., plane 310 in FIG. 3), MCM 200 may provide a point-to-point network among integrated circuits 214 without optical-waveguide crossing that can cause power loss and cross-talk problems.

As noted above and shown in FIG. 3, which presents a block diagram illustrating a single-layer optical link 300 in MCM 200 (FIG. 2), optical waveguides 210 (FIG. 2) and optical waveguides 212 (FIG. 2) may be implemented in the same layer on a substrate. Moreover, a given optical path between a given pair of integrated circuits in the point-to-point network (such as integrated circuits 214-1 and 214-2 in FIG. 2) may include two optical couplers 314 to convey or transfer the given modulated optical signal between plane 310 and plane 312 in the given optical path. For example, optical couplers 314 may include inter-layer optical couplers, such as a mirror, a diffraction grating and/or an optical proximity connector.

Using optical link 300, MCM 200 (FIG. 2) may statically route the optical signals and the modulated optical signals among integrated circuits 214 (FIG. 2). In particular, during operation an optical signal from a source site (such as integrated circuit 214-1 in FIG. 2) is transmitted from bridge chip 216-1 (FIG. 2) to optical waveguide 316 (such as one of optical waveguides 212 in FIG. 2) in layer or plane 310 using one of optical couplers 314. Then, at the destination site (such as integrated circuit 214-2 in FIG. 2) the optical signal is transmitted from the optical waveguide to bridge chip 216-2 (FIG. 2) and a wavelength-selective filter in a receiver ‘picks off’ the carrier wavelength in the optical signal. In this way, every site can communicate using carrier wavelengths in optical waveguides. Note that, in MCM 200 (FIG. 2), optical couplers on the bridge chips for optical waveguides 210 are indicated by squares and optical couplers on the bridge chips for optical waveguides 212 are indicated by circles.

By using two optical couplers in optical links (such as optical link 300), optical losses in the MCM may be reduced. In an exemplary embodiment, a 20×20 cm² MCM includes 64 chips and the optical loss per optical link is reduced by 5.55 dB (3.6×) relative to a two-layered implementation with four inter-layer optical couplers.

In some embodiments, optical waveguides 210 (FIG. 2) and optical waveguides 212 (FIG. 2) are implemented in a semiconductor layer on the substrate, and the optical signals or light in these optical waveguides may be highly confined because of the big difference between the index of refraction of the semiconductor layer and the surrounding material. While a wide variety of materials can be used in the semiconductor layer, in an exemplary embodiment silicon is used. Furthermore, this silicon semiconductor layer may be disposed on a buried-oxide layer which, in turn, is disposed on the substrate. Once again, a wide variety of materials may be used in the substrate, such as a semiconductor, glass or plastic. In an exemplary embodiment, silicon is used in the substrate, along with silicon dioxide in the buried-oxide layer. Consequently, in some embodiments, the substrate, the buried-oxide layer and the semiconductor layer may comprise a silicon-on-insulator (SOI) technology.

Referring back to FIG. 2, in an exemplary embodiment optical waveguides 210 and 212 convey optical signals (i.e., light) having carrier wavelengths between 1.1-1.7 μm, such as an optical signal having a fundamental carrier wavelength of 1.3 or 1.55 μm. These optical waveguides may have thicknesses between 0.25 and 3 μm, and widths between 0.5 and 3 μm. Note that because optical waveguides 210 and 212 may have quasi-rectangular cross-sections, they may be quasi-single mode components. Moreover, the buried-oxide layer may have a thickness between 0.3 and 3 μm.

Note that optical waveguides 210 may provide minimum distance optical-waveguide routing between set of light sources 710 (FIG. 7) and integrated circuits 214 and/or optical waveguides 212 may provide minimum distance optical-waveguide routing among integrated circuits 214.

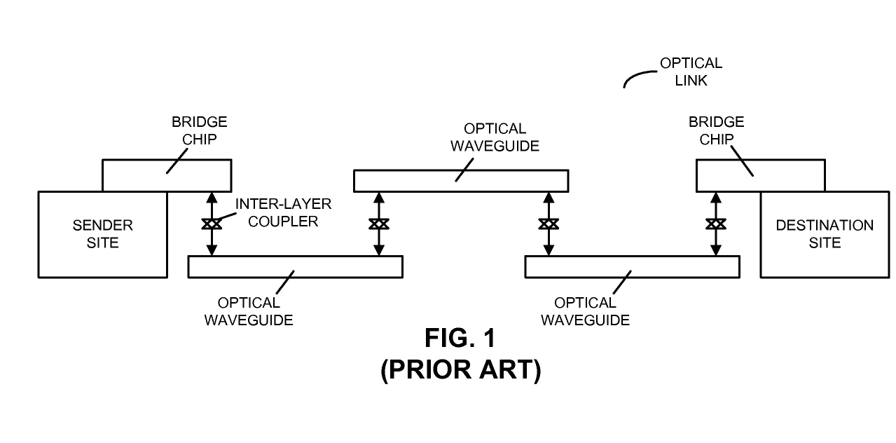

Additionally, the point-to-point network may provide dedicated optical paths or channels among integrated circuits 214 (i.e., each site in the macrochip may have a dedicated point-to-point optical link to every other site via an optical network). Thus, the optical network in FIG. 1 may be a fully connected point-to-point optical network.

In some embodiments, MCM 200 facilitates simultaneous communication among integrated circuits 214. For example, the optical links among integrated circuits 214 may be dedicated optical links.

Note that the point-to-point network may exclude shared resources in optical paths among integrated circuits 214. For example, the optical network may not include optical switches or an arbitration mechanism that prevents collisions during communication.

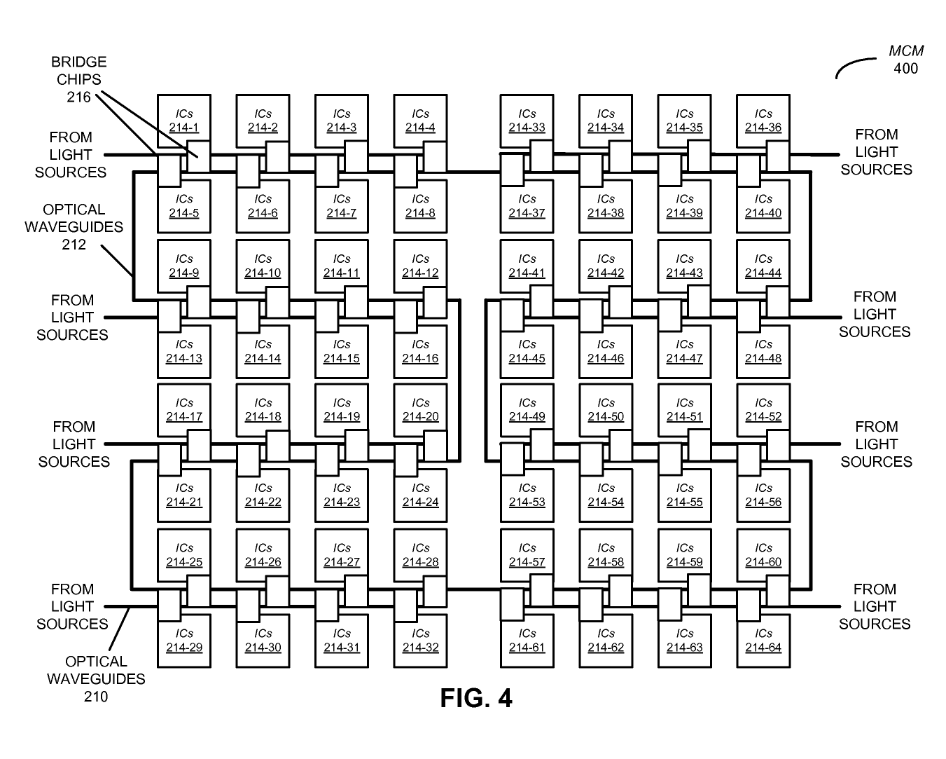

While MCM 200 illustrates a 4×4 planar optical network, the single routing layer in this communication technique may be used in a variety of configurations. Another arrangement is shown in FIG. 4, which presents a block diagram illustrating an MCM 400 with an 8×8 planar point-to-point optical network. This MCM includes (power) optical waveguides 210 and (data) optical waveguides 212. As was the case in MCM 200 (FIG. 2), optical waveguides 210 can deliver optical power from the optical fibers attached to the periphery of the macrochip to the individual sites. Each of optical waveguides 210 may have the same WDM factor as optical waveguides 212. Moreover, optical waveguides 212 may be arranged in ‘closed rings’. In fact, optical waveguides 212 may be implemented as multiple optical-waveguide segments among source and destination sites, so the ‘closed rings’ may actually include overlapping optical-waveguide segments. In an exemplary embodiment, MCM 400 includes 64 optical waveguides 210 and 512 optical waveguides 212.

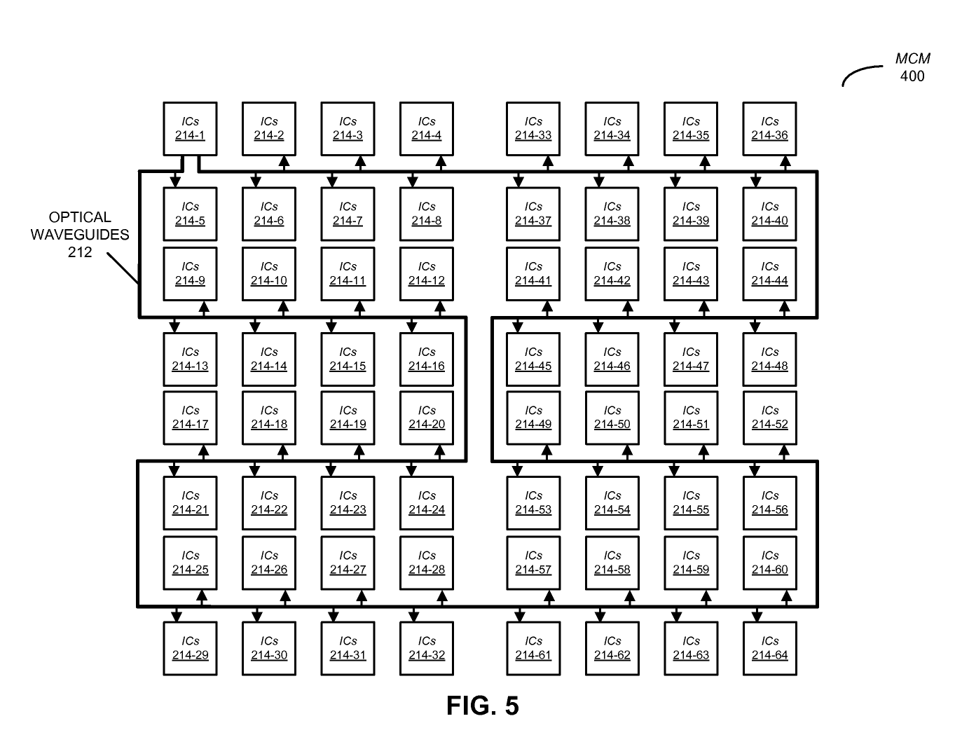

The layout of the optical waveguides from integrated circuit 214-1 to all of the other integrated circuits 214 is shown in FIG. 5, which presents a block diagram illustrating optical routing in MCM 400. In particular, in FIG. 5 half of optical waveguides 212 are routed in the clockwise direction and the other half are routed in the counter-clockwise direction to reduce the maximum optical-waveguide length. Note that each line in FIG. 5 may represent multiple optical waveguides. Moreover, each destination site may remove pre-defined carrier wavelengths from optical waveguides 212. Furthermore, each of optical waveguides 212 may begin at the source and may terminate at the last destination reading out of that optical waveguide. Therefore, not all of optical waveguides 212 may be routed the entire distance around MCM 400.

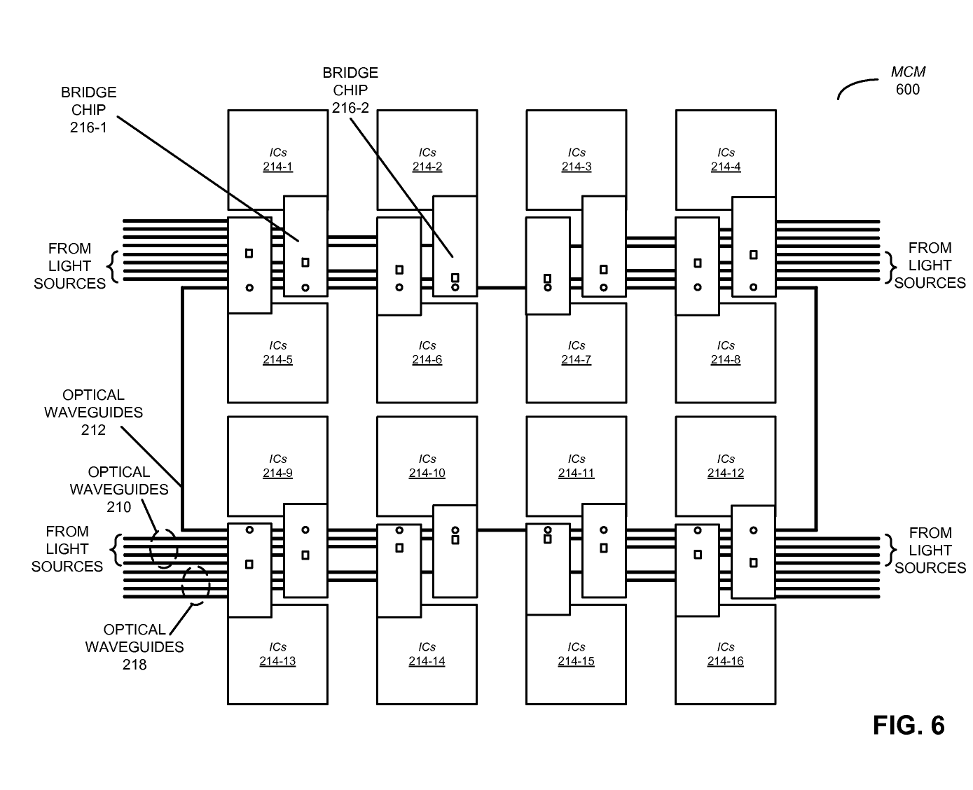

In addition to the power and the data optical waveguides, in some embodiments the MCM includes input/output (I/O) optical waveguides. This is shown in FIG. 6, which presents a block diagram illustrating an MCM 600. In particular, MCM 600 may include optical waveguides 218, optically coupled to bridge chips 216, which convey the modulated optical signals to locations external to MCM 600.

Performance of the aforementioned single-routing layer communication technique may be affected by: the optical-signal loss due to optical components (such as optical couplers); the optical-signal loss due to the distance traveled in the optical waveguides; and the area required for the optical waveguides. Because the optical signal in the planar optical network may only cross two inter-layer optical couplers, the optical-signal loss due to optical components may be reduced. However, the planar point-to-point optical network may have longer data optical waveguide lengths and the same power optical waveguide lengths compared to a two-layer topology. As a consequence, the benefits of the planar optical network may depend on the size of the macochip, the optical-signal loss per unit length of the optical waveguides, and the optical-signal loss of the inter-layer optical couplers.

In general, the planar optical network is more power efficient than an otherwise equivalent two-layer optical network if

ΔLₘₐₓ·WGL<2·OCL,

where ΔLₘₐₓ is the difference in the maximum optical-waveguide distance in the two topologies, WGL is the optical-waveguide loss per centimeter, and OCL is the optical-coupler loss. Currently, WGL is estimated as 0.03 dB and OCL is estimated as 3.0 dB. Therefore, for an 8×8 configuration on a 20×20 cm² macrochip, the planar optical network is predicted to result in a lower total optical-signal loss because the maximum optical-waveguide length is only about 15 cm greater than in the two-layer optical network (approximately 55 cm vs. 40 cm). This results in a 5.55 dB (3.6×) reduction in the optical-link loss. However, with a larger macrochip, the increased optical-waveguide losses may exceed the reduction in the optical-coupler loss. In this case, the two-layer optical network may be preferred.

Note that, while the area on the substrate for the optical waveguides may be greater for the planar optical network than for the two-layer optical network, the area may not exceed the space available and may not result in a reduction in the optical-waveguide capacity.

The preceding embodiments of the MCM may be used in a variety of applications. This is shown in FIG. 7, which presents a block diagram illustrating a system 700. System 700 includes: set of light sources 710 that output optical signals having carrier wavelengths; and MCM 712. For example, set of light sources 710 may include tunable-carrier wavelength lasers that can be tuned to any carrier wavelength in the usable spectrum or non-tunable lasers having fixed carrier wavelengths. This set of light sources may be optically coupled to MCM 712 by optical fiber(s).

System 700 may include: a VLSI circuit, a switch, a hub, a bridge, a router, a communication system, a storage area optical network, a data center, an optical network (such as a local area optical network), and/or a computer system (such as a multiple-core processor computer system). Furthermore, the computer system may include, but is not limited to: a server (such as a multi-socket, multi-rack server), a laptop computer, a communication device or system, a personal computer, a work station, a mainframe computer, a blade, an enterprise computer, a data center, a portable-computing device (such as a tablet computer), a supercomputer, an optical network-attached-storage (NAS) system, a storage-area-network (SAN) system, and/or another electronic computing device. Note that a given computer system may be at one location or may be distributed over multiple, geographically dispersed locations.

The preceding embodiments of the MCM, as well as system 700, may include fewer components or additional components. Although these embodiments are illustrated as having a number of discrete items, these MCMs and the system are intended to be functional descriptions of the various features that may be present rather than structural schematics of the embodiments described herein. Consequently, in these embodiments two or more components may be combined into a single component, and/or a position of one or more components may be changed. For example, set of light sources 710 may be included on the MCM. In addition, functionality in the preceding embodiments of the MCMs and the system may be implemented more in hardware and less in software, or less in hardware and more in software, as is known in the art. For example, functionality may be implemented in one or more application-specific integrated circuits (ASICs) and/or one or more digital signal processors (DSPs).

While the preceding embodiments have been illustrated with particular components, configurations and optical network architectures, a wide variety of additional variations to the optical network in the embodiments of the MCM may be used, as is known to one of skill in the art, including: the use of additional or fewer components, arbitration techniques (as needed), etc.

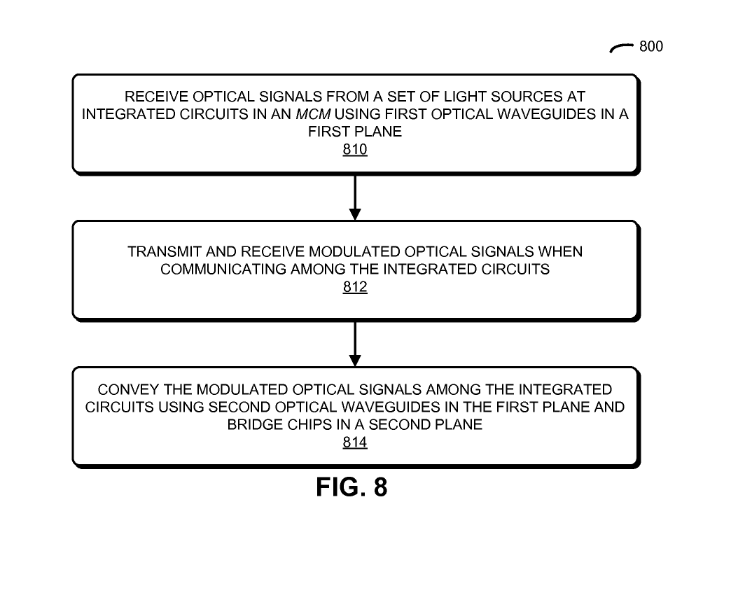

We now describe embodiments of the method. FIG. 8 presents a flow chart illustrating a method 800 for communicating information in an MCM, such as one of the previous embodiments of the MCM. During the method, optical signals are received from a set of light sources, which are external to the MCM, at integrated circuits in the MCM using first optical waveguides in a first plane (operation 810). Then, modulated optical signals are transmitted and received when communicating information among the integrated circuits (operation 812). Next, the modulated optical signals are conveyed among the integrated circuits using second optical waveguides in the first plane and bridge chips in a second plane (operation 814), where the bridge chips optically couple the integrated circuits and the first optical waveguides and optically couple the integrated circuits and the second optical waveguides. Note that the modulated optical signals are conveyed among the integrated circuits using a point-to-point network without optical-waveguide crossing.

In some embodiments of method 800, there are additional or fewer operations. Moreover, the order of the operations may be changed, and/or two or more operations may be combined into a single operation.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A multi-chip module (MCM), comprising:
first optical waveguides, in a first plane, configured to convey optical signals from a set of light sources which are external to the MCM;
integrated circuits configured to receive the optical signals, and configured to transmit and receive modulated optical signals when communicating information among the integrated circuits;
second optical waveguides, in the first plane, configured to convey the modulated optical signals among the integrated circuits; and
bridge chips, in a second plane, optically coupled to the first optical waveguides, the second optical waveguides and the integrated circuits, configured to convey the optical signals from the first optical waveguides to the integrated circuits, and configured to convey the modulated optical signals to and from the second optical waveguides and the integrated circuits, wherein the MCM provides a point-to-point network among the integrated circuits without optical-waveguide crossing.

2. The MCM of claim 1, wherein the first optical waveguides and the second optical waveguides are implemented in the same layer on a substrate.

3. The MCM of claim 2, wherein the first optical waveguides and the second optical waveguides are implemented on the substrate using silicon-on-insulator technology.

4. The MCM of claim 1, wherein the first optical waveguides provide minimum distance optical-waveguide routing between the set of light sources and the integrated circuits.

5. The MCM of claim 1, wherein the second optical waveguides provide minimum distance optical-waveguide routing among the integrated circuits.

6. The MCM of claim 1, wherein the second optical waveguides include multiple overlapping segments among sources and destinations in the integrated circuits.

7. The MCM of claim 1, wherein the point-to-point network provides dedicated optical paths among the integrated circuits.

8. The MCM of claim 1, wherein the MCM is configured for simultaneous communication among the integrated circuits.

9. The MCM of claim 1, wherein the point-to-point network excludes shared resources in optical paths among the integrated circuits.

10. The MCM of claim 1, wherein a given optical path between a given pair of integrated circuits in the point-to-point network includes two optical couplers to convey the given modulated optical signal between the first plane and the second plane in the given optical path.

11. The MCM of claim 1, further comprising third optical waveguides, optically coupled to the bridge chips, configured to convey the modulated optical signals to locations external to the MCM.

12. An system, comprising:
a set of light sources configured to output optical signals having carrier wavelengths; and
a multi-chip module (MCM), wherein the MCM includes:
first optical waveguides, in a first plane, configured to convey the optical signals;
integrated circuits configured to receive the optical signals, and configured to transmit and receive modulated optical signals when communicating information among the integrated circuits;
second optical waveguides, in the first plane, configured to convey the modulated optical signals among the integrated circuits; and
bridge chips, in a second plane, optically coupled to the first optical waveguides, the second optical waveguides and the integrated circuits, configured to convey the optical signals from the first optical waveguides to the integrated circuits, and configured to convey the modulated optical signals to and from the second optical waveguides and the integrated circuits, wherein the MCM provides a point-to-point network among the integrated circuits without optical-waveguide crossing.

13. The system of claim 12, wherein the first optical waveguides and the second optical waveguides are implemented in the same layer on a substrate.

14. The system of claim 12, wherein the second optical waveguides include multiple overlapping segments among sources and destinations in the integrated circuits.

15. The system of claim 12, wherein the point-to-point network provides dedicated optical paths among the integrated circuits.

16. The system of claim 12, wherein the MCM is configured for simultaneous communication among the integrated circuits.

17. The system of claim 12, wherein the point-to-point network excludes shared resources in optical paths among the integrated circuits.

18. The system of claim 12, wherein a given optical path between a given pair of integrated circuits in the point-to-point network includes two optical couplers to convey the given modulated optical signal between the first plane and the second plane in the given optical path.

19. The system of claim 12, further comprising third optical waveguides, optically coupled to the bridge chips, configured to convey the modulated optical signals to locations external to the MCM.

20. A method for communicating information in an MCM, the method comprising:
receiving optical signals from a set of light sources, which are external to the MCM, at integrated circuits in the MCM using first optical waveguides, wherein the first optical waveguides are in a first plane;
transmitting and receiving modulated optical signals when communicating information among the integrated circuits; and
conveying the modulated optical signals among the integrated circuits using second optical waveguides in the first plane and bridge chips in the second plane, wherein the bridge chips optically couple the integrated circuits and the first optical waveguides and optically couple the integrated circuits and the second optical waveguides; and
wherein the modulated optical signals are conveyed among the integrated circuits using a point-to-point network without optical-waveguide crossing.
